(19) United States
(12) Patent Application Publication
(10) Pub. No.: US 2015/0135811 A1
(43) Pub. Date: May 21, 2015

(54) DIAPHRAGM FOR A PRESSURE-MEASURING DEVICE

(71) Applicant: Robert Bosch GmbH, Stuttgart (DE)

(72) Inventors: Janpeter Wolff, Wurmberg (DE); Wolfgang Koetzle, Ehningen (DE); Thomas Hauber, Altbach (DE); Stefan Leopold, Kirchheim Am Neckar (DE); Denis Gugel, Pliezhausen (DE)

(21) Appl. No.: 14/400,474

(22) PCT Filed: Apr. 30, 2013
(86) PCT No.: PCT/EP2013/058941

§ 371 Date: Nov. 12, 2014

(30) Foreign Application Priority Data
May 11, 2012 (DE) 10 2012 207 856.8

(51) Int. Cl. G01L 7/08; G01L 19/14; G01M 15/08

(52) U.S. Cl. CPC G01L 7/082; G01M 15/08; G01L 19/14
USPC 73/114.18

(57) ABSTRACT

Described is an elastic diaphragm for a pressure-measuring device for ascertaining a pressure in a combustion chamber of an internal combustion engine, especially a self-ignitable internal combustion engine, the diaphragm being accommodated in a housing of the pressure-measuring device in order to separate a pressure chamber from a cavity and in order to seal the housing from the pressure to be measured. The diaphragm has a pressure-application region. Furthermore, the diaphragm is developed in the shape of a ring and in cross-section has a U-shape that is open toward the cavity; the region of the diaphragm on which the pressure is acting is geometrically made up of two interconnected quarter circles, so that the pressurized region has a structure that is self-supporting with respect to the arising combustion pressure loads.

### FIELD OF THE INVENTION

The present invention is based on an elastic diaphragm. The subject matter of the present invention is a diaphragm for a pressure-measuring device for ascertaining a pressure in a combustion chamber of an internal combustion engine, especially a self-igniting internal combustion engine.

### BACKGROUND INFORMATION

It is well known that such pressure-measuring devices are either provided separately from a glow plug in the combustion chamber, or that they could also be provided integrated into a glow plug. Situated within a glow plug or sheathed-element glow plug in the combustion chamber to be measured is a glow pin, which acts as pressure-transmission element, via which a pressure prevailing in the combustion chamber is transmitted to a pressure sensor module, which is mechanically linked to the glow pin and also situated within the glow plug or which is linked thereto. As an alternative, a support tube, also referred to as glow tube, which guides the glow pin, may be provided as pressure-transmission element. A corresponding glow plug, where the pressure-sensor module is situated within the glow plug, is generally made up of a glow pin (possibly guided within a glow tube), which is supported in a sensor housing via a connection sleeve in a manner that allows movement in the axial direction; the sensor housing in turn is situated in a sealing cone housing, which serves as the outer shell of the glow plug. A basically similar construction can be gathered from FIG. 1. Starting from the top of the heating pin, also known as glow tip, the sensor module in this case is situated in the glow plug behind or above the glow pin supported in an axially displaceable manner, and is mechanically linked thereto, so that a pressure force generated by the combustion and acting to the glow pin, the glow tip is transmitted to the sensor module by the glow pin (or the glow tube) in its function as pressure-transmission element. A main problem in this context is that the media present in the combustion chamber and penetrating the tip of the glow plug can destroy the sensor module and the connected electronics on account of their temperature during the combustion and on account of their chemical properties. Elastic diaphragms, as described further below, have already been developed in the past in an effort to prevent this from happening.

German Published Patent Application No. 10 2006 057 627 describes a pressure-measuring device, which is meant to be placed in the combustion chamber of a self-igniting internal combustion engine. The pressure-measuring device described there takes the form of a glow plug and includes a housing, a force-transmission element in the form of a rod-shaped heating element that partially projects from the housing at a chamber-side opening of the housing, and a pressure sensor. The latter is disposed in an interior space of the housing of the pressure-measuring device and is mechanically linked to the force-transmission element. In addition, a cylindrical diaphragm is provided, which seals the interior space of the housing in which the pressure sensor is situated from the combustion-chamber-side opening. The diaphragm, which may be developed as a metal diaphragm, has a force-transmission segment that is oriented in an axial direction of the force-transmission element. In this development of a pressure-measuring device, the pressure sensor is mechanically linked to the force-transmission element via the force-transmission segment. In this way thermally conditioned changes in length of the diaphragm which, for instance, are the result of hot fuel gases and may lead to periodic adverse effects on the pressure measurement, are at least partially compensated.

Moreover, a sheathed element glow plug, which is to be installed in a combustion chamber of a self-igniting internal combustion engine, is known from German Published Patent Application No.10 2007 049 971. The sheathed element glow plug has a housing, a force-transmission element in the form of a rod-shaped heating element that partially projects from the housing, and a pressure sensor, which is disposed in an interior space of the housing of the glow plug. On one side, the pressure sensor is mechanically linked to the rod-shaped heating element for detecting an impingement on the heating element as a result of a pressure prevailing in the chamber, so that the pressure prevailing in the chamber is able to be ascertained. Furthermore, on the other side the pressure sensor is braced on a fixation element connected to the housing. A diaphragm, in this instance in particular a spring diaphragm, seals the interior space of the housing from the combustion chamber of the internal combustion engine. The spring diaphragm is developed as an S-shaped spring diaphragm in cross-section. Because of this development, it is possible to achieve a pressure-balanced design, in particular, so that the accuracy of a pressure measurement by the pressure sensor is able to be improved.

Inside a combustion pressure sensor, the diaphragm thus is generally required to seal the interior space of the sheathed-element glow plug or the pressure-measuring device from the combustion chamber, in order to prevent the penetrating media from rapidly destroying the components of the sensor module and the electronics due to their temperature and aggressive chemical properties. At the same time, however, the diaphragm should also stand up to the stresses during the sensor operation over the longest service life possible, such stresses essentially including the cyclical loads of the pressure change (several hundred million load changes per service life) as well as the high level of the average temperature. Moreover, it is necessary to prevent a varying sensitivity of the pressure-measuring device and resulting measuring errors (the so-called “calibration factor” effect), which arise from changes in the average temperature at the diaphragm, for instance as a result of different engine load states. In addition, short-term effects within a load application that also lead to measuring errors must be prevented, such as the so-called thermo shock effect, in which rapid, shock-like variations of the temperature at the diaphragm lead to mechanical stresses between the outer and inner part of the diaphragm material, because the heat is conducted more rapidly to, or is dissipated from, the surface than to or from the interior.

To satisfy these demands, diaphragms have already been developed which have support systems that can prevent an excessive deformation of the diaphragm by specially developed support elements. A decisive disadvantage of such diaphragm modules provided with a support area is a test-proven dependency of the pressure measurement signal on the contact point of the diaphragm on the support area of the support element. Depending on the pressure and temperature loads that occur during the operation of the combustion chamber sensor, this contact point may shift, so that the measuring sensitivity of the measuring signal in response to pressure varies in an undesired manner.

### SUMMARY

In contrast, the elastic diaphragm of the present invention has the advantage that the sensor interior space is able to be sealed adequately, and support areas are dispensed with by optimizing the geometry of the diaphragm in an effort to avoid excessive tensile stresses in the diaphragm. More precisely, this advantage is achieved by an elastic diaphragm for a pressure-measuring device for ascertaining a pressure in a combustion chamber of an internal combustion engine, especially a self-igniting internal combustion engine; the diaphragm is accommodated in a housing of the pressure-measuring device, that is, within a sealing cone housing of a glow plug disposed within the combustion chamber, in order to seal a so-called pressure chamber from a so-called cavity within the glow plug and to seal the housing from the pressure to be measured in the combustion chamber. The diaphragm includes a pressure-application region, on which the pressure prevailing in the combustion chamber is acting for the most part when the internal combustion engine is operating. The diaphragm is developed in the shape of a ring, its cross-section having a U-shape that is open in the direction of the cavity; the region of the diaphragm on which the pressure is acting is geometrically formed by two inter-connected quarter circles, so that the pressurized region has a structure that is self-supporting with respect to the arising combustion pressure loads. The described U-shaped cross-section of the diaphragm alone already achieves geometrical stability with regard to pressure acting from the outside, similar to the principle of a retaining dam, and the diaphragm may generally have a softer design, both in terms of material and dimensions. In one preferred specific embodiment of the elastic diaphragm, the radially outer leg of the U-shape of the diaphragm is shorter than the radially inner leg of the U-shape, thereby allowing better guidance of the glow pin through the diaphragm and easier accessibility of the fixation regions or the regions to be welded between the glow pin and diaphragm.

The two quarter circles that substantially specify the cross-sectional form of the diaphragm are preferably interconnected via a straight, i.e., non-curved, end face of the region on which the pressure is acting, so that a U-form which is flattened at the lower end results for the diaphragm. This has the advantage that the diaphragm is easy to produce, such as by a deep-drawing process or the like. In one preferred specific embodiment of the elastic diaphragm according to the present invention, the two quarter circles of the region on which the pressure is acting have different radii, so that the loading of the diaphragm or the sensitivity of the entire pressure measuring system is able to be adapted to variable radii of the sealing cone housing and a measuring function can be optimized. The quarter circles preferably have essentially identical radii.

In one alternative development of the elastic diaphragm according to the present invention, the two quarter circles jointly form a semicircle, without an end face being formed between them. The partially semicircular U-shape of the diaphragm that is obtainable in this manner makes it possible to achieve maximum static stability of the diaphragm by way of geometry, and once again results in a longer service life of the diaphragm.

In addition, the radially outer leg of the U-shaped diaphragm is preferably connected to the housing of the pressure-measuring device, and the radially inner leg of the U-shaped diaphragm is connected to a force-transmission element of the pressure-measuring device, the glow pin of the glow plug, for example, acting as force-transmission element. However, the force-transmission element may also be a support tube of the glow pin of the glow plug, or in the case of a pure pressure-measuring device, i.e., a pressure-measuring device that is provided apart from a glow plug, it may be a metal pin without any heating function at all. Such a fixed connection of the diaphragm between the force-transmission element and the housing of the pressure-measuring device ensures that the cavity in the interior of the pressure-measuring device is sealed from the pressure chamber in a fluid-tight manner. The connections between the diaphragm and the housing or the force-transmission element may be welded connections. In one further preferable development of the elastic diaphragm according to the present invention, the diaphragm is a deep-drawn component and/or a metal diaphragm, which has the advantage that the diaphragm is easy to produce and exhibits a high load-change stiffness.

### BRIEF DESCRIPTION OF THE DRAWINGS

FIG. 1 a sectional view of a cutaway of a glow plug having an elastic diaphragm according to the first preferred specific embodiment of the present invention.

FIG. 2 a sectional detail illustration of the elastic diaphragm shown in FIG. 1.

FIG. 3 a sectional detail illustration of an elastic diaphragm according to a second preferred specific embodiment of the present invention.

### DETAILED DESCRIPTION

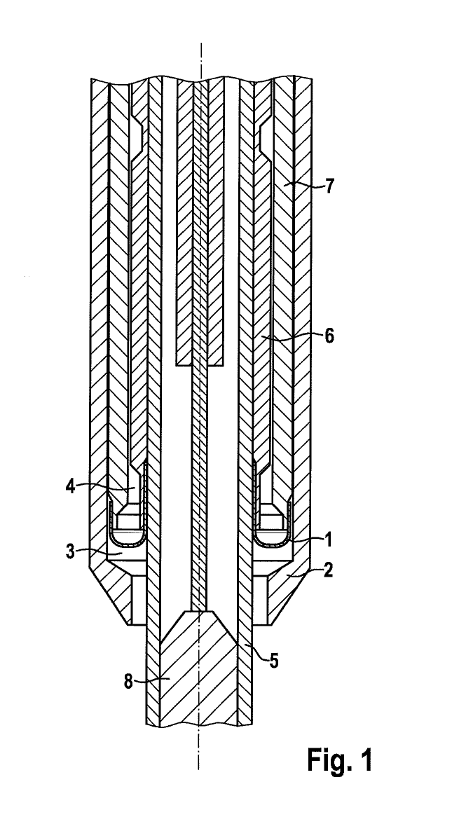

FIG. 1 shows a sectional detail view of an elastic diaphragm 1 of the present invention according to a first preferred specific embodiment in a glow plug. Diaphragm 1 is disposed between a glow plug housing, i.e., glow plug sealing cone housing 2, and a support tube 5 of the glow pin, i.e., a glow tube 5, while the glow plug itself is situated within a cylinder head (not shown) of a self-igniting internal combustion engine. Instead of glow tube 5, which acts as force-transmission element 5 of the pressure-measuring device in the first preferred specific embodiment, it is also conceivable that a glow pin 8 is directly provided as force-transmission element and is in contact with diaphragm 1. However, any other cylindrical force-transmission element would be conceivable as well, such as a simple cylindrical metal pin or the like; in this case, it would no longer be a glow plug but alternatively thereto, a pure pressure-measuring device.

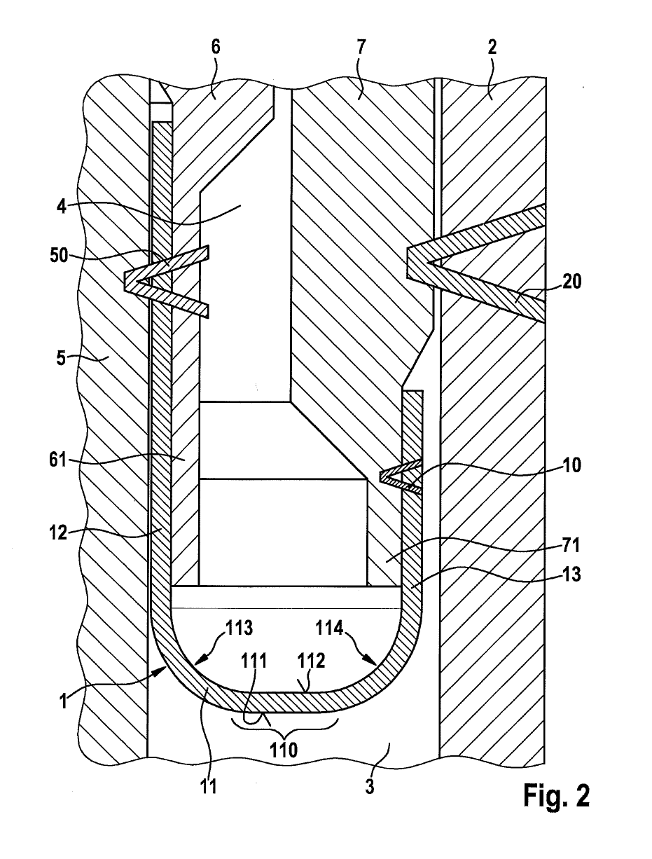

Elastic diaphragm 1 has an annular form and on its radially inner side is in contact with glow tube 5, and on its radially outer side is in contact with sensor housing 7. As can be gathered from FIG. 1 and FIG. 2, an end 61 of a connection sleeve 6 firmly connects diaphragm 1 to glow tube 5 at the radially inner side by means of a welding seam 50. At the radially outer side, on the other hand, diaphragm 1 is connected to an end 71 of sensor housing 7 by a welded seam 10, and sensor housing 7 itself is fixed in place on housing 2 by welded seam 20. End 71 of sensor housing 7 and also end 61 of connection sleeve 6 have forms that taper gradually in cross-section, so that recesses are produced in which diaphragm 1 can be placed. Such a connection layout ensures that a cavity 4 situated in the interior of the glow plug is sealed in a fluid-tight manner from a pressure chamber 3 which is likewise situated in the interior of the glow plug, so that no combustion gases from pressure chamber 3, which is in fluidic connection with the combustion chamber (not shown) of a cylinder of the internal combustion engine, are able to penetrate cavity 4. Elastic diaphragm 1, on which pressure from pressure chamber 3 is acting beginning at welded seam 50 and up to the contact at sensor housing 7, in general has a U-shaped cross-section, the U-shape of diaphragm 1 including a bottom section 11, which represents the so-called pressure-application region 11 of diaphragm 1. Pressure-application region 11 has an outer side, i.e., underside 111, which is exposed in the direction of pressure chamber 3 when the glow plug is in operation, so that the combustion pressure of each combustion cycle within the cylinder is acting on the outer side, or underside 111, of diaphragm 1. Furthermore, pressure-application region 11 has an inner side, i.e., topside 112, which is situated in the direction of the interior of the U-shape of diaphragm 1, i.e., in the direction of cavity 4. In addition, the U-shape of diaphragm 1 has a long leg 12, which is situated radially on the inside, and a short leg 13, which is situated radially on the outside, long leg 12 being connected to end 61 of connection sleeve 6, and short leg 13 being connected to end 71 of sensor housing 7, so that both connection sleeve 6 and sensor housing 7 are situated within the U-shaped cross-section of diaphragm 1.

According to FIG. 2, in terms of geometry, pressure-application region 11 is formed by a first quarter circle 113 and a second quarter circle 114, between which a straight end face 110 is situated. In this specific embodiment, each quarter circle 113 and 114 has a radius that is essentially the same as that of the other.

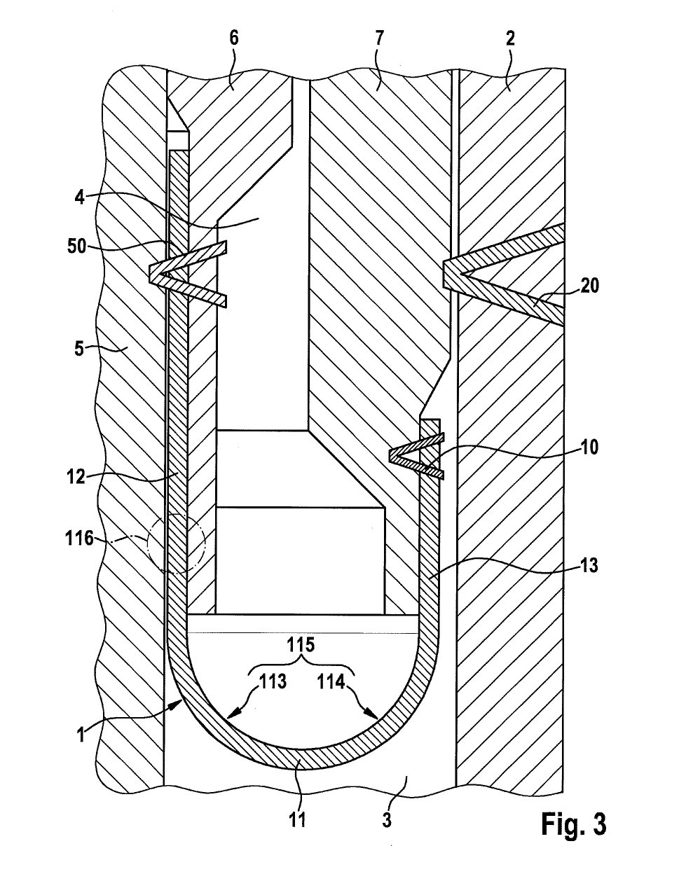

A second preferred embodiment of elastic diaphragm 1 according to the present invention is depicted in FIG. 3. The general configuration of diaphragm 1 in this specific embodiment is similar to the configuration in the first preferred specific embodiment and will therefore not be discussed again. In this instance, pressure-application region 11 of the second preferred specific embodiment of diaphragm 1 is geometrically made up of two directly connected quarter circles 113 and 114 in cross-section, between which no end face is situated, so that the two quarter circles 113 and 114 form a semicircle 115, which makes up the entire pressure-application region 11 with regard to its shape. When using diaphragm 1 according to the second preferred specific embodiment of the present invention, in testing region 116 of diaphragm is subjected to a considerably lower stress load when acted upon by a combustion chamber pressure (from below) in the combustion chamber. This considerably increases the service life of elastic diaphragm 1, because the tensile stresses in diaphragm 1 are able to be minimized In addition, a considerably improved constancy of the sensitivity across pressure and temperature loads is achieved.

1-9. (canceled)

10. An elastic diaphragm for a pressure-measuring device for ascertaining a pressure in a combustion chamber of an internal combustion engine, comprising:
a body accommodated in a housing of the pressure-measuring device in order to separate a pressure chamber from a cavity and in order to seal the housing from the pressure to be measured, wherein:
the diaphragm includes a pressure-application region,
the diaphragm is developed in the form of a ring and has a U-shape in cross-section that is open in the direction of the cavity, and
the pressure-application region is geometrically formed by two interconnected quarter circles, so that the pressure-application region has a structure that is self-supporting in response to occurring pressure loads.

11. The elastic diaphragm according to claim 10, wherein the internal combustion engine is a self-igniting internal combustion engine.

12. The elastic diaphragm according to claim 10, wherein a radially outer leg of the U-shape is shorter than a radially inner leg of the U-shape.

13. The elastic diaphragm as recited in claim 10, wherein the two quarter circles are interconnected via a straight end face of the pressure-application region.

14. The elastic diaphragm as recited in claim 10, wherein the two quarter circles have different radii.

15. The elastic diaphragm as recited in claim 10, wherein the quarter circles have essentially identical radii.

16. The elastic diaphragm as recited in claim 10, wherein the two quarter circles form a semicircle.

17. The elastic diaphragm as recited in claim 12, wherein the radially outer leg of the U-shaped diaphragm is connected to the housing of the pressure-measuring device, and wherein
the radially inner leg of the U-shaped diaphragm is connected to a force-transmission element of the pressure-measuring device.

18. The elastic diaphragm as recited in claim 17, wherein the connections are welded connections.

19. The elastic diaphragm as recited in claim 10, wherein the diaphragm at least one of is a deep-drawn component and is a metal diaphragm.
